(19) United States
(12) Patent Application Publication
(10) Pub. No.: US 2004/0162043 A1
(43) Pub. Date: Aug. 19, 2004

(54) System and method for compensating receiver gain using a mixed signal technique by implementing both automatic gain control (AGC) and bit-normalization

(75) Inventors: David B. Taubenheim, Plantation, FL (US); Zhitao Jiang, Chandler, AZ (US)

Correspondence Address: MILLER JOHNSON SNELL CUMMISKEY, PLC, 800 CALDER PLAZA BUILDING, 250 MONROE AVE N W, GRAND RAPIDS, MI, 49503-2250, US

(73) Assignee: Motorola, Inc.

(21) Appl. No.: 10/367,009

(22) Filed: Feb. 14, 2003

(51) Int. Cl. H04B 17/02

(52) U.S. Cl. 455/136; 455/138

(57) ABSTRACT

A system for compensating radio frequency (RF) receiver gain (400) by implementing both automatic gain control (AGC) and digital normalization where the receiver includes at least one front-end configurable gain stage (401) for providing selectable gain to the receiver. An analog-to-digital converter (ADC) (407) for converting an analog input signal from the configurable gain stage (407) to a digital signal. An AGC controller (405) is then used to determine a level of gain of a received input signal and controlling the front-end configurable gain stage (401). A digital normalizer (411) then truncates the digital data from both the ADC (407) and subsequent digital stages for maximizing the dynamic range of the receiver. The invention offers advantages in controlling receiver gain when in crowded band conditions with many potentially interfering signals are present with a desired signal.

### TECHNICAL FIELD

This invention relates in general to radio frequency (RF) receivers and more particularly to input data recovery in the receiver while in the presence of strong interfering in-band signals.

### BACKGROUND

Automatic gain control (AGC) logic is typically used in radio frequency (RF) receiver design in order to adjust levels of analog signals throughout the receiver architecture. This enables the recovery of data with minimal hardware despite problems with input signal reception such as in-band interference, fading, or overloading. In order to design a receiver with very broad receiving capability, there are a number of problems associated with receiver performance, namely 1) a gain correcting mechanism that can deal with both in-band and out-of-band interference due to shared spectrum and relaxed filter requirements and; 2) a gain control mechanism the can respond quickly enough to ensure the preamble of a digital signal is received successfully yet low enough in complexity to be low cost.

Various techniques for controlling the amplitude of an input signal have been used for many years in order to prevent overload in the front-end stages of a RF receiver. These techniques typically have included continually monitoring the amplitude of the input signal and varying the gain of the front-end amplification stage in order to maintain the input signal at some predetermined signal level. These conventional techniques become more difficult to implement when using a wide bandwidth receiver where there are many interfering signals located along with the signals the user desires to receive. With the advent of integrated circuit (IC) design, general analog techniques were applied to the IC design with AGC circuits placed on chip to control the gain of the front end stage. As with all standard AGC designs, these were used to prevent over amplification and distortion of the amplified RF input signal.

Additional problems associated with traditional AGC circuits include an increase the amount of current drain used by the IC. Since the device is continuously monitoring the input signal rather than performing these operations periodically in discrete gain steps this leads to an increase in overall current drain. In a world where portability is paramount, the elimination every milliamp of current drain becomes even more important to promote longer battery life.

Thus, the need exists to provide a highly effective, low cost, low current drain apparatus and method that can be used to enhance a received RF signal while mitigating the received signal characteristics over attenuation, overload and distortion.

### SUMMARY OF THE INVENTION

Briefly, according to the invention, there is provided an apparatus and method for adjusting analog and digital signal levels in an RF receiver by using both AGC and digital normalization logic. By adjusting signal levels throughout the receiver architecture, a level of amplification is attained such that data recovery normally not recoverable is now possible. The invention allows the amplitudes of interfering signals to be reduced while the desired received signal is digitally normalized such that its amplitude is increased to some predetermined level. The invention is most advantageous for constant-envelope spreading-spectrum modulation schemes when there are narrowband interfering signals within the RF receiver's bandwidth or the desired input signal is experiencing fading or clipping. The logic used to control the AGC and digital normalization provide operating modes to allow the gain of the input to be tracked throughout a received digital data packet or until some point in a received packet. As compared with prior art AGC techniques, the present invention offers benefits in complexity, timing, and interference mitigation.

### BRIEF DESCRIPTION OF THE DRAWINGS

The features of the present invention, which are believed to be novel, are set forth with particularity in the appended claims. The invention, together with further objects and advantages thereof, may best be understood by reference to the following description, taken in conjunction with the accompanying drawings, in the several figures of which like reference numerals identify like elements, and in which:

FIG. 1 is a diagram illustrating the frequency spectrum of an input signal whose gain is controlled by AGC with no in-band interference.

FIG. 2 is a diagram illustrating the frequency spectrum of an input signal in the presence of interference whose gain is not controlled by AGC or digital normalization using techniques of the present invention.

FIG. 3 is a diagram illustrating the frequency spectrum of an input signal of FIG. 2 whose gain is controlled both by AGC and digital normalization of the present invention.

FIG. 4 is a block diagram illustrating a receiver architecture with AGC and digital normalizer of the present invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward.

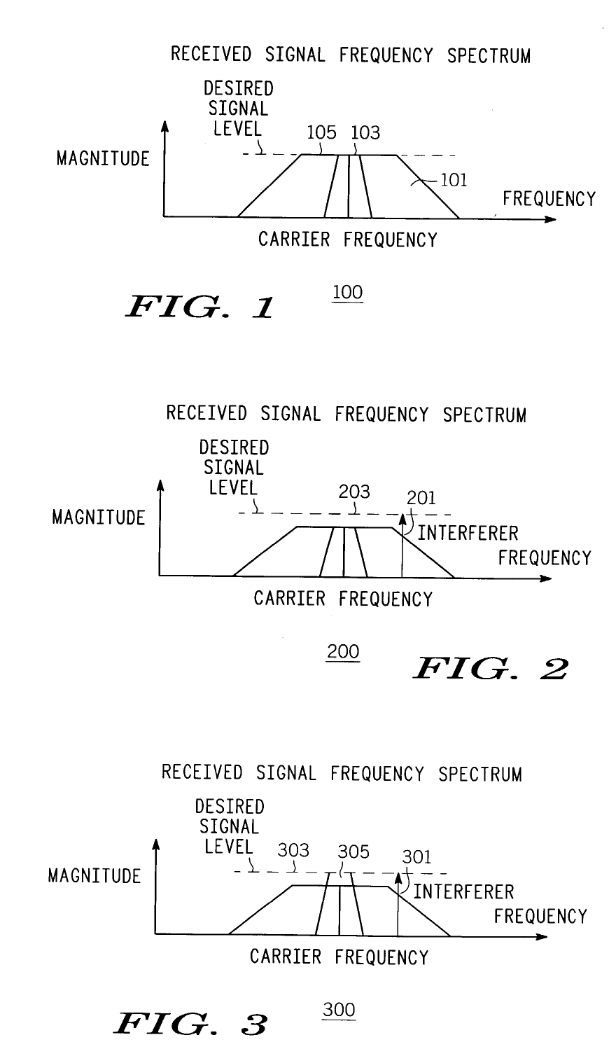

Referring now to FIG. 1, a spectral diagram 100 illustrating the frequency response of a bandlimited input signal processed by an AGC where there is no interfere to degrade or desense receiver performance. As seen in the illustration, the unshaded signal area 101 represents the signal's frequency response at the output of the receiver front-end amplification stage. The shaded area 103 represents the frequency response at the back-end of the receiver after baseband filtering and despreading. Although not to scale, the diagram 100 shows the input signal's frequency response with no interference present. The AGC will provide enough gain to raise the amplitude of the received input signal up to some predetermined level 105.

FIG. 2 illustrates a spectral diagram 200 illustrating the signal response of an input signal that is not controlled by a system using an AGC and digital normalizer as described in the present invention. The diagram shows operation of a conventional AGC so a desired signal that is to be received is compressed due to the presence of an interfering signal. Since an interfering signal 201 is present, the input signal is reduced in amplitude along with the interfering signal 201 to a point where the desired signal is less than or equal to the predetermined threshold level 203. As can be seen in the diagram, not only is the amplitude of desired input signal reduced, but it is compressed at the back-end stages of the receiver to a point that the input signal may no longer be intelligible.

FIG. 3 illustrates a spectral diagram 300 illustrating the signal response of the input signal when in the presence of an interfering signal when used with the system and method of the present invention. The invention utilizes AGC at the front-end stage of the RF receiver to amplify the input signal and to digitally normalize the signal at the back-end stage of the receiver. As seen in FIG. 3, the interfering signal 301 is attenuated at or below the desired signal level 303, however the desired input signal amplitude 305 is increased to the predetermined signal level 303. Thus, the present system and method offers great advantages in situations where there are highly crowded band conditions. In these types of situations, the level of interfering signals need to be reduced while the level of desired input signal is increased for further processing and demodulation by the receiver. FIG. 3 shows the desired results where the desired input signal is returned to a predetermined level despite the presence of an interfering signal.

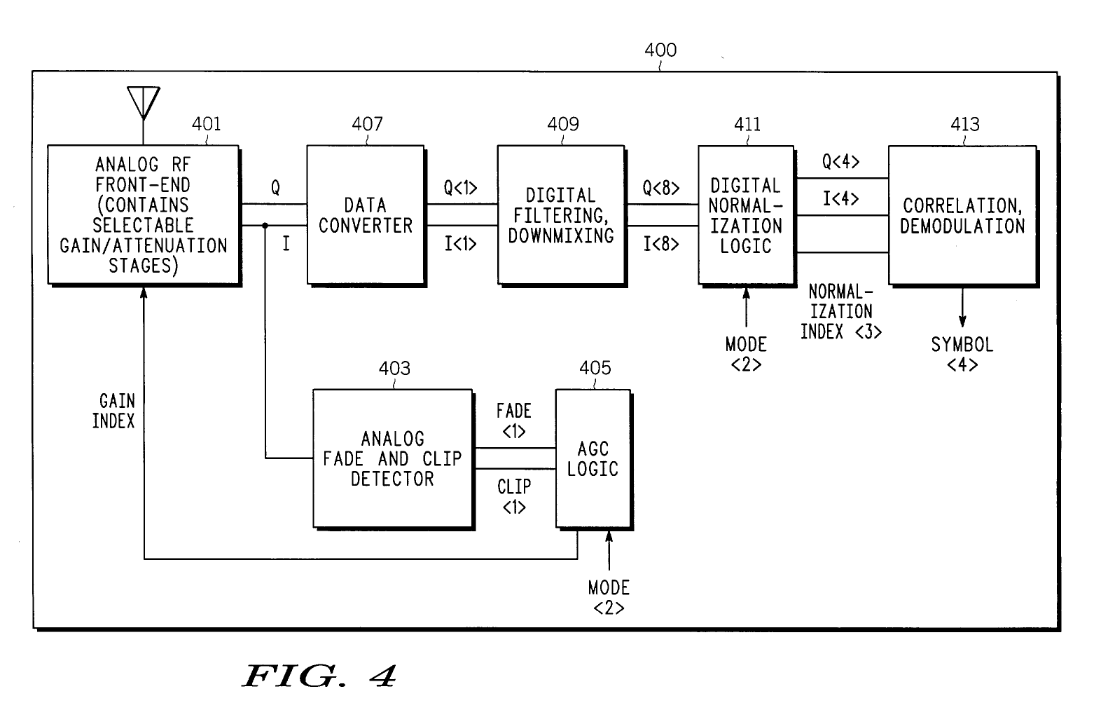

FIG. 4 is a block diagram of a receiver 400 utilizing a system and method for compensating receiver gain using the mixed signal technique according to the present invention. Radio frequency (RF) signals are received by the analog front-end 401. The analog front-end include one or more RF amplifier and/or attenuator stages typically offering 6 dB or any chosen step size. The RF amplifier and/or attenuator stages are positioned in a series or cascade configuration in order to achieve optimal effect. By selectively activating and/or deactivating the various amplifiers/attenuators in the front-end 401, the gain of the RF input signal that is presented to subsequent receiver stages can be precisely controlled. Signals amplified by the front-end 401 are sent to a analog-to-digital converter 407 where they are converted to digital signals having in-phase (I) and quadrature (Q) components. Although shown here as a complex signal, those skilled in the art will recognize that depending on the modulation scheme resolving the input signal the conversion to in-phase (I) and/or quadrature (Q) signal components may not be necessary.

In order to maintain a relatively constant input signal level to the receiver, an automatic gain control (AGC) selects the level of amplification or gain of the received signal to keep the input to the analog-to-digital (ADC) converter 407 at or near an optimum level to maximize the signal-to-noise (SNR) ratio into the digital signal path. In order to detect clipping (i.e., “over driving”) and fading of the input signal, an analog fade and clip detector 403 is used. The fade and clip detector 403 includes two or more analog comparators (not shown) that are sampled to detect both clipping and fading. Thus, as will be recognized by those skilled in the art, if the input signal level into the analog-to-digital converter (ADC) 407 falls below a predetermined voltage amplitude level and meets certain statistical conditions, a “fade event” occurs. Similarly, if the signal level exceeds a predetermined voltage amplitude level and meets certain statistical conditions, a “clip event” occurs. Depending on how often one of these events occur in a specified interval, the gain/attenuation stages within the front-end 401 are enabled or disabled by AGC logic 405 to compensate for these events. This allows the input signal to be maintained at some predetermined threshold level to maintain a reasonable SNR. It will also be recognized by a skilled artisan that ADC 407 may be any type of ADC topology including but not limited to that of a sigma-delta ADC.

At the output of the ADC 407 a digital filtering and mixing network 409 is used to filter unwanted signal components and down mix the in-phase and quadrature digital signals from ADC 407 from the predetermined baseband intermediate frequency (IF). It will further be recognized by those skilled in the art that downmixing and filtering are optional processing steps, depending on the topology of the RF front end used in connection with the present invention. At the output of the filtering and mixing network 409 a digital normalizer 411 is used to determine the proper truncation of data words and/or packets. Although any bit width may be selected for the data words, by way of example the data shown herein is truncated from 8 bits to 4 bits in length so that the resulting 4 bit signal peaks between a range of 0.5 and 1.0 absolute. The digital normalizer 411 works concurrently with and independently from the AGC using a similar clip/fade event-driven algorithm. Depending on how often a fade/clip event occurs in a specified interval during the 8 bit to 4 bit truncation, arithmetic left shifting or right shifting occurs on the data stream to maintain normalization between 0.5 and 1.0 absolute. Numerical saturation at the output of the bit normalizer 411 output is used to minimize the effect of the occasional overdrive.

Thus, in order to provide a highly versatile AGC and digital normalizer system, at least three different modes of operation will be available. As seen in FIG. 4, these modes are controlled though a mode port present at both the AGC logic 405 and the digital normalizer 411. Any of the modes most appropriate for a specific signal environment can be chosen using these mode ports. The modes use a programmed value as the gain index and track gain though the digital packet. These include 1) using programmed values as the gain indices for the AGC and digital normalizer; 2) tracking the gain throughout the packet; and 3) tracking the gain until a common event in the packet, such as the preamble, is detected and then freezing that gain value thereafter until the next packet. Hence the AGC 405 and bit normalizer may be operated depending on required conditions in either a no tracking mode, programmed gain mode, track continuously mode, or track until a valid digital signal is detected mode.

Finally, at the output of the digital normalizer 411 the normalized signal is further processed using digital signal processing (DSP) so the signal is correlated and demodulated for further interpretation and processing by the receiver 400.

Hence the invention offer great advantages in RF receiver design and operation when attempting to receive signals in very crowded band conditions. One application of this invention might be applied to the 2.4 GHz wireless spectrum where many digital signal of various types are present. The invention allows a desired signal to be easily processed by the receiver in the presence of strong interfering in-band or out-of-band signals are present.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

What is claimed is:

1. A system for compensating radio frequency (RF) receiver gain by implementing both automatic gain control (AGC) and digital normalization the receiver comprising:
at least one front-end configurable gain stage;
an analog-to-digital converter (ADC) for converting an analog input signal from the at least one configurable gain stage to a digital signal;
an AGC controller for determining a level of gain of a received input signal and controlling the at least one front-end configurable gain stage; and
a digital normalizer for truncating digital data from the ADC or subsequent digital stages for maximizing the dynamic range of the receiver.

2. A system for compensating RF receiver gain as in claim 1, wherein the at least one front-end configurable gain stage includes a series of cascaded analog amplifiers and attenuations that whose gain is individually controlled by the AGC controller.

3. A system for compensating RF receiver gain as in claim 1, further comprising:
an analog-to-digital converter (ADC) positioned between the AGC controller and the digital normalizer.

4. A system for compensating RF receiver gain as in claim 1, wherein the ADC is a sigma-delta ADC.

5. A system for compensating RF receiver gain as in claim 1, wherein the AGC controller operates in a plurality of modes including a no tracking mode, programmed gain mode, track continuously mode, or track until a valid digital signal is detected mode.

6. A radio frequency (RF) receiver that includes a system for compensating receiver gain using both automatic gain control (AGC) and digital normalization comprising:
an analog front-end gain stage including a plurality of cascaded amplifiers and/or attenuators;
an analog-to-digital converter (ADC) for converting analog input signals from the analog front-end gain stage to digital signals;
an automatic gain controller for determining the amount of gain from an analog clip/fade detector and adjusting the gain of the analog front-end stage according to a set of predetermined conditions; and
a digital normalizer for adjusting the level of the digital signals after the analog front-end gain stage to optimize digital demodulation of a received input signal.

7. A RF receiver as in claim 6, further comprising a digital demodulator for decoding a signal from the digital normalizer.

8. A RF receiver as in claim 6, further comprising a fade and clip detector for detecting when an input signal is above or below a predetermined threshold for use by the automatic gain controller.

9. An RF receiver as in claim 6, wherein the ADC is a sigma-delta ADC for providing high resolution and low current drain.

10. An RF receiver as in claim 6, wherein the automatic gain controller determines the amount of gain of the analog front-end gain stage based upon a predetermined amount of signal interference, fading or clipping of the input signal.

11. A method for adjusting the levels of signal gain throughout a radio frequency (RF) receiver using both an automatic gain control (AGC) and a digital normalizer comprising the steps of:
providing at least one front-end gain stage for processing an RF input signal;
detecting the RF input signal level and the amount of fading and clipping of the RF input signal;
controlling the amount of gain of the at least one front-end gain stage based upon a set of predetermined conditions;
converting the analog signal from the at least one gain stage to a digital signal; and
truncating the digital baseband signal using a digital normalizer to reduce the computational complexity of the digital baseband receiver and increasing dynamic range of the RF receiver.

12. A method for adjusting levels of signal gain as in claim 11, further comprising the step of:
demodulating the truncated baseband signal for processing by the RF receiver.

13. A method for adjusting level of signal gain as in claim 11, wherein the gain of the at least one front-end gain stage includes both amplification and attenuation.

14. A method for adjusting level of signal gain as in claim 11, wherein processing the RF input signal includes either amplification or attenuation.

15. A method for adjusting the levels of signal gain as in claim 11, wherein the front-end gain stage includes a plurality of individually controlled amplifier stages.

16. A method for adjusting the levels of signal gain as in claim 11, wherein the step of controlling the amount of gain further includes:
detecting the statistics of a minimum number of fading and clipping events on the RF input signal using a plurality of comparators and digital analysis.

17. A method for adjusting the levels of signal gain as in claim 11, wherein the step of converting includes using a analog-to-digital converter (ADC).

18. A method for adjusting the levels of signal gain as in claim 11, wherein the ADC is a sigma-delta ADC.
